(19) United States
(12) Patent Application Publication
(10) Pub. No.: US 2008/0058972 A1
(43) Pub. Date: Mar. 6, 2008

(54) Data selection system, data selection apparatus, data selection method, and data selection program

(76) Inventor: Michiaki Yoneda, Kanagawa (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/713,033

(22) Filed: Mar. 2, 2007

(30) Foreign Application Priority Data
Sep. 3, 2006 (JP) 2006-064589

(51) Int. Cl. G06F 17/00; H04B 5/00

(52) U.S. Cl. 700/94; 381/79

(57) ABSTRACT

A data selection system includes a data transmission apparatus and a data playback apparatus. The data transmission apparatus transmits pieces of data to be continuously played back in at least one data format. The data playback apparatus refines the data format of the data transmitted from the data transmission apparatus on the basis of at least one playback condition for refining the data format of the data transmitted from the data transmission apparatus.

### CROSS REFERENCES TO RELATED APPLICATIONS

The present invention contains subject matter related to Japanese Patent Application JP 2006-064589 filed in the Japanese Patent Office on Mar. 9, 2006, the entire contents of which are incorporated herein by reference.

### BACKGROUND OF THE INVENTION

1. Field of the Invention

The present invention relates to data selection systems, data selection apparatuses, data selection methods, and data selection programs. The present invention is preferably applied to selection of a piece of data from multiple pieces of data.

2. Description of the Related Art

Data selection apparatuses that select a piece of data from multiple pieces of data stored in storage media on the basis of search conditions specified by users are known (for example, Japanese Unexamined Patent Application Publication No. 2003-167918). Such data selection apparatuses are applied to, for example, audio players. Some audio players select a piece of audio data from multiple pieces of audio data (audio data concerning music pieces) stored in hard disks on the basis of search keywords, such as the names of albums, music pieces, and/or artists, specified by users and play back the selected piece of the audio data.

Some audio players not only play back audio data stored in own hard disks but also receive audio data provided by servers on networks over the networks to perform streaming playback to the audio data. In this case, the audio players request, for example, the servers to transmit the audio data corresponding to the search conditions, such as the names of albums, music pieces, and/or artists, specified by the users and receive the audio data provided by the servers in response to the requests.

### SUMMARY OF THE INVENTION

Although the audio data, described above, provided by the servers on the basis of the search keywords including the names of albums, music pieces, and/or artists concerns music pieces corresponding to the search keywords, the audio data is not necessarily suitable for playback in the audio players. Since pieces of the audio data practically have various data formats, even the pieces of the audio data corresponding to the search keywords do not necessarily have data formats suitable for the playback in the audio players.

Accordingly, there is a problem in the related art in that it is difficult to select data suitable for the playback in playback apparatuses.

It is desirable to provide a data selection system capable of selecting data suitable for playback in a playback apparatus.

According to an embodiment of the present invention, a data selection system includes a data transmission apparatus and a data playback apparatus. The data transmission apparatus transmits pieces of data to be continuously played back in at least one data format. The data playback apparatus refines the data format of the data transmitted from the data transmission apparatus on the basis of at least one playback condition for refining the data format of the data transmitted from the data transmission apparatus.

According to another embodiment of the present invention, a data selection apparatus includes refining means for refining at least one data format of data to be continuously played back and to be transmitted from a data transmission apparatus to a data playback apparatus on the basis of a playback condition which the data playback apparatus uses in reception and playback of the data.

According to another embodiment of the present invention, a data selection method includes the step of refining at least one data format of data to be continuously played back and to be transmitted from a data transmission apparatus to a data playback apparatus on the basis of a playback condition which the data playback apparatus uses in reception and playback of the data.

According to another embodiment of the present invention, a data selection program causes an information processing apparatus to execute the step of refining at least one data format of data to be continuously played back and to be transmitted from a data transmission apparatus to a data playback apparatus on the basis of a playback condition which the data playback apparatus uses in reception and playback of the data.

According to the present invention, at least one data format of data to be continuously played back and to be transmitted from a data transmission apparatus to a data playback apparatus is refined on the basis of a playback condition which the data playback apparatus uses in reception and playback of the data, so that the data having the data format suitable for the playback in the data playback apparatus can be selected. Consequently, it is possible to realize the data selection system, the data selection apparatus, the data selection method, and the data selection program which are capable of selecting the data suitable for the playback in the playback apparatus.

### DESCRIPTION OF THE DRAWINGS

FIG. 1 shows an example of the configuration of an audio system according to a first embodiment of the present invention;

FIG. 2 shows connection between a communication module and a cradle in the audio system according to the first embodiment of the present invention;

FIG. 3 is a block diagram showing an example of the configuration of the communication module according to the first embodiment of the present invention;

FIG. 4 is a block diagram showing an example of the configuration of the cradle according to the first embodiment of the present invention;

FIG. 5 is a block diagram showing an example of the configuration of a server according to the first embodiment of the present invention;

FIG. 6 shows an example of a provision data list according to the first embodiment of the present invention;

FIG. 7 shows another example of the provision data list according to the first embodiment of the present invention;

FIG. 8 shows a playback data list in wired connection according to the first embodiment of the present invention;

FIG. 9 shows the playback data list in wireless connection according to the first embodiment of the present invention;

FIG. 10 is a flowchart showing a process of playing back audio data according to the first embodiment of the present invention;

FIG. 11 shows an example of how the playback data list is displayed according to the first embodiment of the present invention;

FIG. 12 is a flowchart showing a process of playing back the audio data according to a second embodiment of the present invention;

FIG. 13 shows an example of the provision data list according to another embodiment of the present invention;

FIG. 14 shows an example of the playback data list according to another embodiment of the present invention;

FIG. 15 shows an example of how the playback data list is displayed according to another embodiment of the present invention;

FIG. 16 shows another example of the playback data list according to another embodiment of the present invention;

FIG. 17 shows another example of the playback data list according to another embodiment of the present invention;

FIG. 18 shows another example of how the playback data list is displayed according to another embodiment of the present invention; and

FIG. 19 shows another example of how the playback data list is displayed according to another embodiment of the present invention.

### DESCRIPTION OF THE PREFERRED EMBODIMENTS

Embodiments of the present invention will now be described in detail with reference to the attached drawings.

### First Embodiment

### Configuration of Audio System

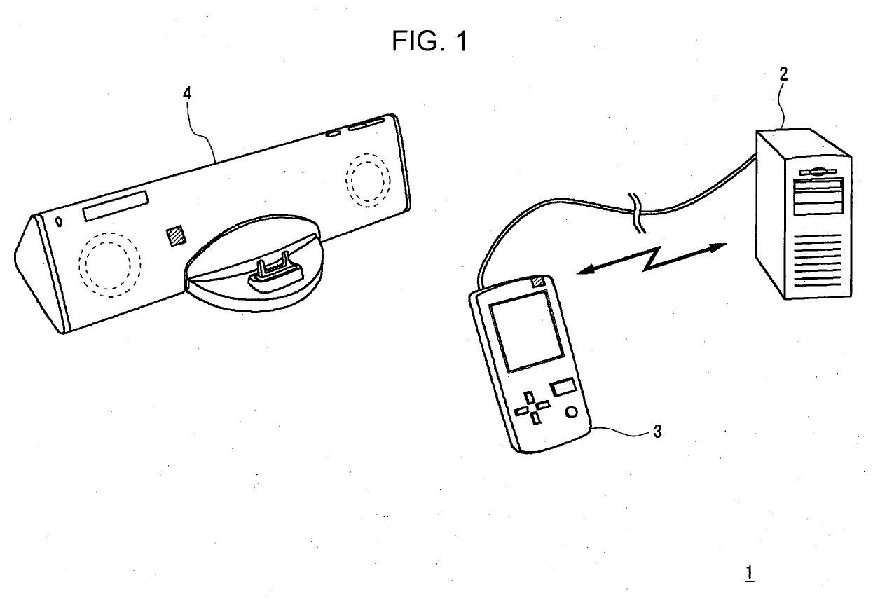

FIG. 1 shows an example of the configuration of an audio system 1 according to a first embodiment of the present invention. The audio system 1 includes a server 2, a communication module 3, and a cradle 4. The server 2 provides audio data concerning music pieces. Wired or wireless connection is established between the server 2 and the communication module 3 over a network. The cradle 4 includes a speaker and is electrically connected to the communication module 3 with the communication module 3 being mounted thereon.

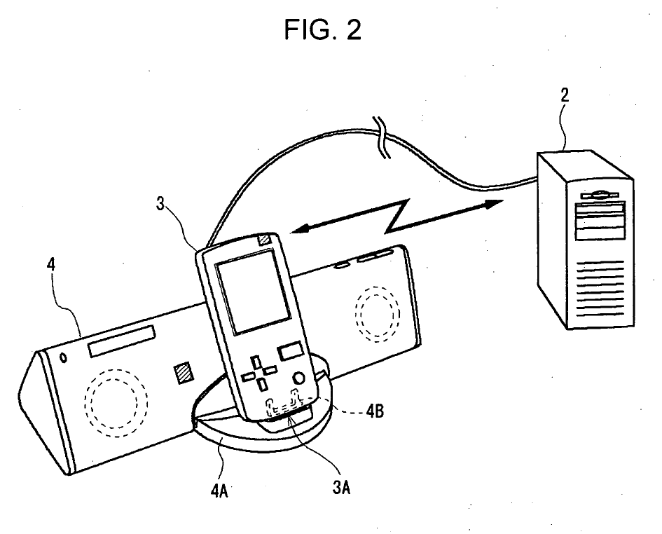

FIG. 2 shows a state in which the communication module 3 is mounted on the cradle 4 in the audio system 1 according to the first embodiment of the present invention. The communication module 3 is mounted on a mounting base 4A provided in a predetermined position of the cradle 4 in a predetermined orientation. The mounting base 4A has a connection terminal (hereinafter referred to as a cradle-side terminal) 4B. A mounting-base contact surface 3A of the communication module 3 also has a connection terminal (not shown) (hereinafter referred to as a module-side terminal).

When the communication module 3 is mounted on the mounting base 4A of the cradle 4, the module-side terminal is contact with the cradle-side terminal 4B to electrically connect the communication module 3 to the cradle 4. It is assumed in the following description that the communication module 3 is connected to the cradle 4.

### Configurations of Communication Module, Cradle, and Server

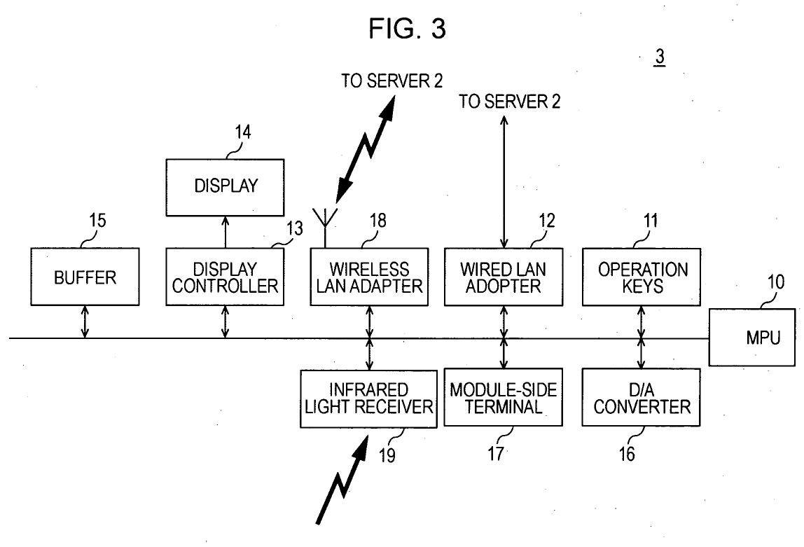

Examples of the configurations of the server 2, the communication module 3, and the cradle 4 will now be described. FIG. 3 is a block diagram showing an example of the configuration of the communication module 3 according to the first embodiment of the present invention. The communication module 3 is capable of wired communication with the server 2 according to a wired local area network (LAN) standard, such as Ethernet, having a maximum communication speed of 100 Mbps and is also capable of wireless communication with the server 2 according to a wireless LAN standard, such as Institute of Electrical and Electronic Engineers (IEEE) 802.11, having a maximum communication speed of 11 Mbps. In the communication module 3, a micro processing unit (MPU) 10 executes programs read out from a memory (not shown) in the MPU 10 to control the entire communication module 3.

Specifically, if the MPU 10 in the communication module 3 recognizes a list acquisition operation in which a list of audio data (hereinafter referred to as a provision data list, described in detail below) which the server 2 can supply is acquired with operation keys 11 when the wired connection is established between the communication module 3 and the server 2, the MPU 10 in the communication module 3 transmits a list request signal for requesting the provision data list from the server 2 through a wired LAN adopter 12. After the MPU 10 receives the provision data list from the server 2 through the wired LAN adopter 12 in response to the list request signal, the MPU 10 generates a list of audio data (hereinafter referred to as a playback data list, described in detail below) to be played back in the communication module 3 and the cradle 4 on the basis of the received provision data list and displays the playback data list in a display 14 through a display controller 13.

If the MPU 10 recognizes a playback operation in which an arbitrary piece of the audio data is selected from the pieces of the audio data described in the playback data list, for example, with the operation keys 11 after the playback data list is displayed in the display 14 in the above manner, the MPU 10 transmits an audio data request signal for requesting the selected piece of the audio data to the server 2 through the wired LAN adopter 12. After the transmission of the audio data from the server 2 is started in response to the audio data request signal, the MPU 10 receives the audio data through the wired LAN adopter 12 while sequentially writing the received audio data in a buffer 15. In the first embodiment of the present invention, it is assumed that the audio data transmitted from the server 2 has a liner pulse code modulation (PCM) format that has been subjected to digital processing, such as a decoding process, in the server 2.

After the audio data corresponding to, for example, several seconds is accumulated in the buffer 15, the MPU 10 supplies the accumulated audio data to a digital-to-analog (D/A) converter 16 and removes the accumulated audio data from the buffer 15 to wait for accumulation of the audio data corresponding to several seconds in the buffer 15. The D/A converter 16 performs a digital-to-analog conversion process to the supplied audio data to yield an audio signal and transmits the audio signal to the cradle 4 through a module-side terminal 17 connected to the cradle-side terminal 4B. As a result, a sound based on the audio signal transmitted to the cradle 4 is output from the speaker built in the cradle 4. In the following description, the sequential digital-to-analog conversion of the received audio data is also called a streaming playback process.

When the wireless connection is established between the communication module 3 and the server 2, the MPU 10 transmits the list request signal to the server 2 through a wireless LAN adapter 18 and receives the provision data list transmitted from the server 2 in response to the list request signal through the wireless LAN adapter 18. The MPU 10 also transmits the audio data request signal to the server 2 through the wireless LAN adapter 18 and receives the audio data transmitted from the server 2 in response to the audio data request signal through the wireless LAN adapter 18.

In the manner described above, the communication module 3 outputs the sound resulting from the streaming playback of the audio data having the linear PCM format, supplied from the server 2 by the wired or wireless transmission, through the speaker included in the cradle 4. In addition, when the communication module 3 is connected to the cradle 4, the communication module 3 charges a built-in battery (not shown) with power supplied from the cradle 4 through the module-side terminal 17.

The communication module 3 further includes an infrared light receiver 19. The communication module 3 receives an infrared signal transmitted from a remote controller (not shown) with the infrared light receiver 19 to convert the received infrared signal into an instruction. In sum, the communication module 3 not only performs a variety of processing in accordance with the operations with the operation keys 11 but also is capable of performing a variety of processing in accordance with the operations with the remote controller to be subjected to the remote control.

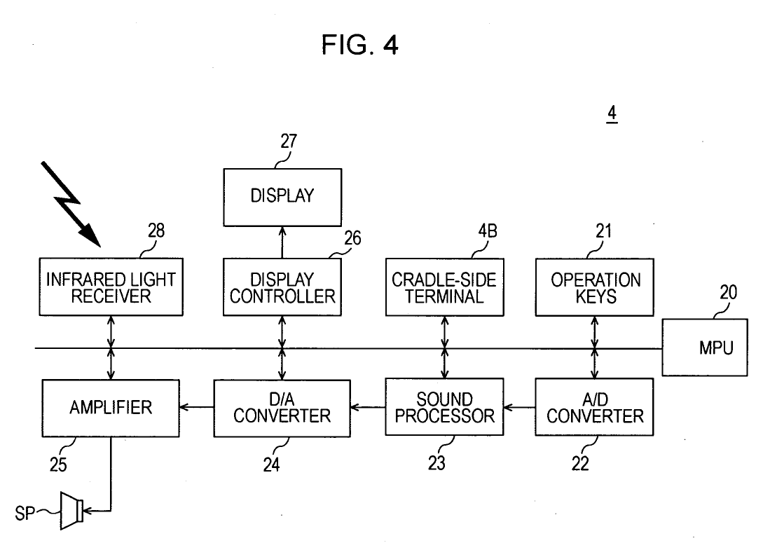

FIG. 4 is a block diagram showing an example of the configuration of the cradle 4 according to the first embodiment of the present invention. The cradle 4 receives power supplied through an alternating current (AC) adopter (not shown) to operate. In the cradle 4, an MPU 20 executes programs read out from a memory (not shown) included therein to control the entire cradle 4.

Specifically, when the cradle 4 is turned on with operation keys 21, the cradle 4 is activated. If the communication module 3 is mounted on and connected to the mounting base 4A, the cradle 4 supplies the power to the communication module 3 through the cradle-side terminal 4B.

When the MPU 20 in the cradle 4 receives an audio signal transmitted from the communication module 3 connected to the cradle 4 through the cradle-side terminal 4B, the MPU 20 supplies the received audio signal to an analog-to-digital (A/D) converter 22.

The A/D converter 22 performs analog-to-digital conversion to the audio signal to yield audio data and supplies the audio data to a sound processor 23. The sound processor 23 performs digital processing, such as equalization, to the audio data supplied from the A/D converter 22 and supplies the audio data subjected to the digital processing to a D/A converter 24.

The D/A converter 24 performs digital-to-analog conversion to the audio data supplied from the sound processor 23 to yield an audio signal and supplies the audio signal to an amplifier 25. The amplifier 25 amplifies the audio signal and outputs a sound based on the amplified audio signal through a speaker SP connected to a speaker terminal (not shown).

In the manner described above, the cradle 4 charges the communication module 3 connected thereto via the cradle-side terminal 4B and outputs the sound based on the audio signal transmitted from the communication module 3 through the speaker SP.

The MPU 20 in the cradle 4 displays a variety of information including the volume and the current time in a display 27 via a display controller 26.

The cradle 4 further includes an infrared light receiver 28. The cradle 4 receives an infrared signal transmitted from a remote controller (not shown) with the infrared light receiver 28 to convert the received infrared signal into an instruction. In sum, the cradle 4 not only performs a variety of processing in accordance with the operations with the operation keys 21 but also is capable of performing a variety of processing in accordance with the operations with the remote controller to be subjected to the remote control.

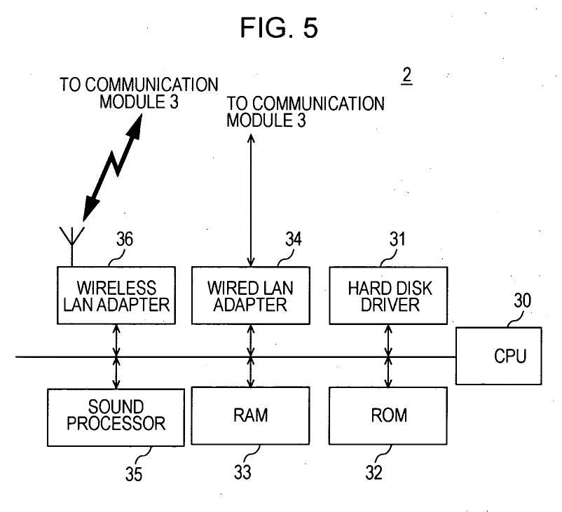

FIG. 5 is a block diagram showing an example of the configuration of the server 2 according to the first embodiment of the present invention. The server 2 is capable of wired communication and wireless communication with the communication module 3 according to the same wired and wireless LAN standards as in the communication module 3. A CPU 30 in the server 2 decompresses programs read out from a hard disk drive 31 or a read only memory (ROM) 32 in a random access memory (RAM) 33 and executes the programs to control the entire server 2 and to perform a variety of processing. The CPU 30 temporarily stores data used in the variety of processing in the RAM 33.

Specifically, if the CPU 30 receives the list request signal requesting the provision data list from the communication module 3 through a wired LAN adopter 34 when the wired connection is established between the server 2 and the communication module 3, the CPU 30 transmits the provision data list to the communication module 3 through the wired LAN adopter 34 in response to the list request signal. The provision data list is generated, for example, when the audio data is stored in the hard disk drive 31, and is stored in the hard disk drive 31.

If the CPU 30 receives the audio data request signal from the communication module 3 through the wired LAN adopter 34 after transmitting the provision data list, the CPU 30 reads out audio data corresponding to the audio data request signal from the hard disk drive 31.

Each piece of the audio data stored in the hard disk drive 31 corresponds to, for example, one music piece. The audio data is compressed and encoded in MPEG-1 Audio Layer-3 (mp3) format having a sampling frequency “44.1 kHz”, a sampling bit rate “16 bits”, the number of channels “2ch”, and a bit rate “128 kbps” indicating the data transfer rate.

The CPU 30 performs digital processing, such as decoding, to the readout audio data having the mp3 format in a sound processor 35 and transmits the audio data subjected to the digital processing to the communication module 3 through the wired LAN adopter 34.

The sound processor 35 performs the digital processing to the audio data having the mp3 format to convert the audio data into audio data having a linear PCM format having a sampling frequency “44.1 kHz”, a sampling bit rate “16 bits”, the number of channels “2ch”, and a bit rate “1411.2 kbps” or into audio data having a linear PCM format having a sampling frequency “96 kHz”, a sampling bit rate “20 bits”, the number of channels “2ch”, and a bit rate “4608 kbps”. In other words, the sound processor 35 converts the audio data having the mp3 format into the audio data having either of the two linear PCM formats with different bit rates and transmits the audio data having either of the two linear PCM formats to the communication module 3.

In contrast, if the CPU 30 receives the list request signal from the communication module 3 through a wireless LAN adopter 36 when the wireless connection is established between the server 2 and the communication module 3, the CPU 30 transmits the provision data list to the communication module 3 through the wireless LAN adopter 36 in response to the list request signal. If the CPU 30 receives the audio data request signal from the communication module 3 through the wireless LAN adopter 36 when the wireless connection is established between the server 2 and the communication module 3, the CPU 30 transmits the audio data to the communication module 3 through the wireless LAN adopter 36 in response to the audio data request signal.

In the manner described above, the server 2 supplies the provision data list and the audio data having either of the two linear PCM formats with different bit rates to the communication module 3 by the wired or wireless transmission in response to the requests from the communication module 3.

The server 2 is also capable of transmitting the audio data having the mp3 format, read out from the hard disk drive 31, to the communication module 3 without converting the format. In other words, the server 2 is capable of transmitting the audio data concerning each music piece, in the three data formats including the mp3 format and the two linear PCM formats with different bit rates, to the communication module 3.

### Structures of Provision Data List and Playback Data List

Examples of the structures of the provision data list transmitted from the server 2 to the communication module 3 and of the playback data list generated in the communication module 3 on the basis of the provision data list will now be described in detail.

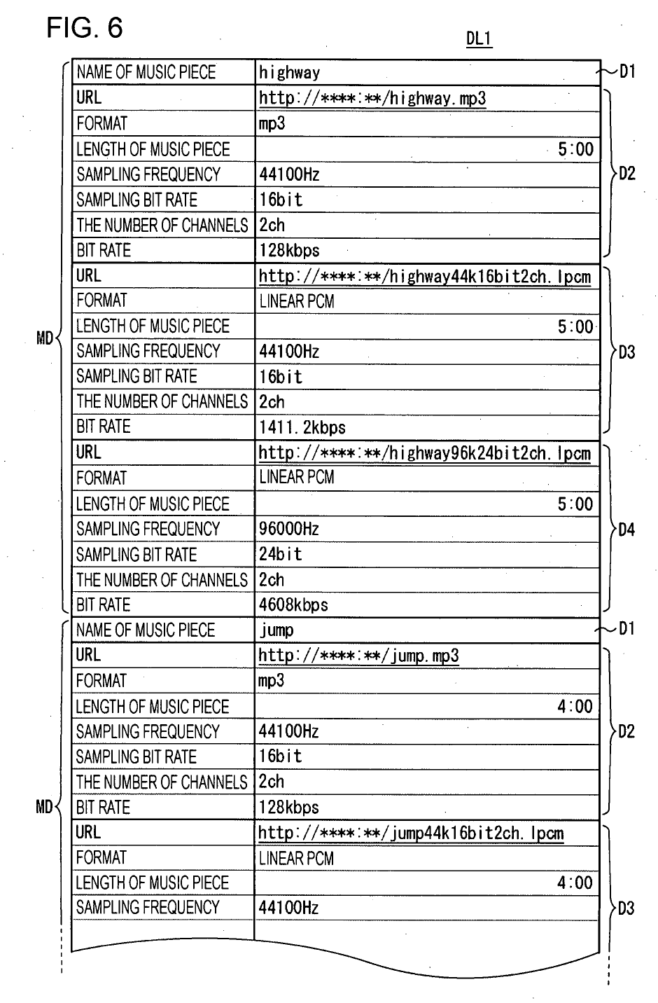

First, an example of the structure of the provision data list will be described with reference to FIG. 6. As shown in FIG. 6, a provision data list DL1 includes attribute information indicating the attributes of the audio data having the three data formats for every music piece which the server 2 can supply. Specifically, the provision data list DL1 includes music name information D1 indicating the name of a music piece; attribute information D2 concerning the audio data having the mp3 format, corresponding to the music name information D1; attribute information D3 concerning the audio data having the linear PCM format with the bit rate “1411.2 kbps”, corresponding to the music name information D1; and attribute information D4 concerning the audio data having the linear PCM format with the bit rate “4608 kbps”, corresponding to the music name information D1, as information for every music piece (hereinafter referred to as “music piece information”) MD.

The attribute information D2, the attribute information D3, and the attribute information D4 each include a uniform resource locator (URL) used for identifying the audio data corresponding to the music name information D1, the format of the audio data, the length of the music piece, the sampling frequency, the sampling bit rate, the number of channels, and the bit rate.

The URL (for example, “http://***:**/highway.mp3”) described in each of the attribute information D2, the attribute information D3, and the attribute information D4 includes a portion (“http://***:**”) indicating the address of the server 2 providing the audio data corresponding to the music name information D1, a portion (“highway”) indicating the file name and music name of the audio data, and a portion (“mp3”) that corresponds to the extension and that indicates the format of the audio data. That is, the address of the server 2 and the file name, music name, and format of the audio data are shown in the URL.

The file names of the audio data included in the URLs of the attribute information D3 and the attribute information D4 also include the sampling frequency, the sampling bit rate, and the number of channels used for calculating the bit rate, in addition to the music name, as in “highway44k16 bit2ch”. That is, the bit rate of the audio data, in addition to the file name, music name, and format of the audio data, are shown in the URLs of the attribute information D3 and the attribute information D4.

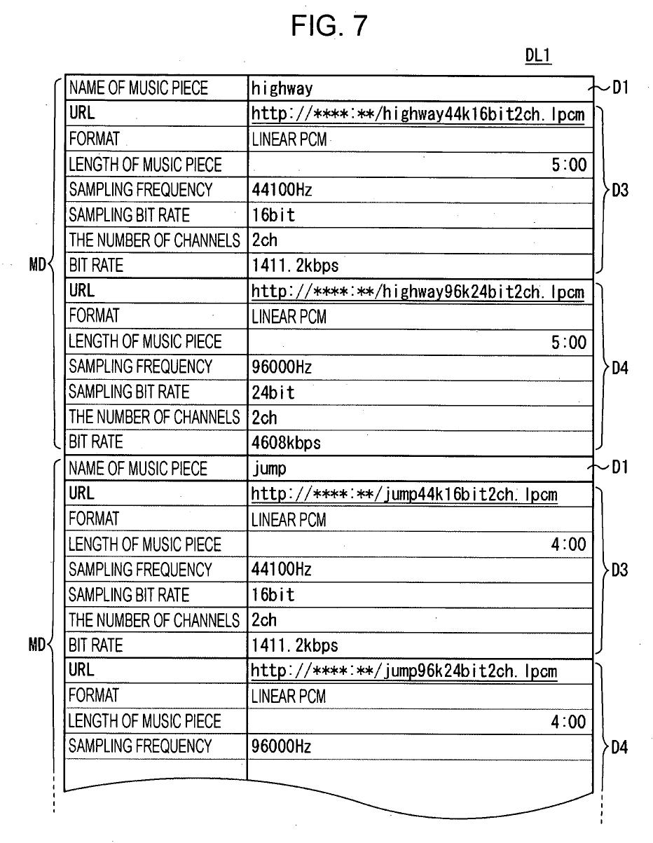

Examples of the structure of a playback data list DL2 will be described in detail with reference to FIGS. 7 to 9. The playback data list DL2 is generated on the basis of the provision data list DL1 which the communication module 3 has received from the server 2. A process of generating the playback data list DL2 will now be described.

After receiving the provision data list DL1 from the server 2, the communication module 3 deletes the attribute information D2 concerning the audio data having the mp3 format, which is not suitable for the streaming playback in the configuration of the communication module 3 connected to the cradle 4, among the formats described in the attribute information D2, the attribute information D3, and the attribute information D4 in the music piece information MD, from the provision data list DL1. As a result, as in an example shown in FIG. 7, the music name information D1, the attribute information D3 concerning the audio data that can be subjected to the streaming playback in the configuration of the communication module 3 connected to the cradle 4 and that has the linear PCM format with the bit rate “1411.2 kbps”, and the attribute information D4 concerning the audio data that can be subjected to the streaming playback in the configuration of the communication module 3 connected to the cradle 4 and that has the linear PCM format with the bit rate “4608 kbps” remain in each music piece information MD in the provision data list DL1.

The communication module 3 deletes the attribute information D3 or the attribute information D4 in each music piece information MD from the provision data list DL1 in accordance with determination of whether the communication module 3 is connected to the server 2 according to the wired LAN standard having a maximum communication speed of 100 Mbps or the wireless LAN standard having a maximum communication speed of 11 Mbps.

If the communication module 3 is connected to the server 2 according to the wired LAN standard having a maximum communication speed of 100 Mbps, the audio data can be reliably transmitted from the server 2 to the communication module 3 without dropping the data (that is, without any sound break) because it is possible to ensure a communication speed sufficient to transmit the audio data regardless of the audio data having the linear PCM format with the bit rate “1411.2 kbps” or the audio data having the linear PCM format with the bit rate “4608 kbps”.

Accordingly, the communication module 3 keeps the attribute information D4 concerning the audio data having the linear PCM format with a higher sound quality and the higher bit rate and deletes the attribute information D3 concerning the audio data having the linear PCM format with the lower bit rate from the provision data list DL1.

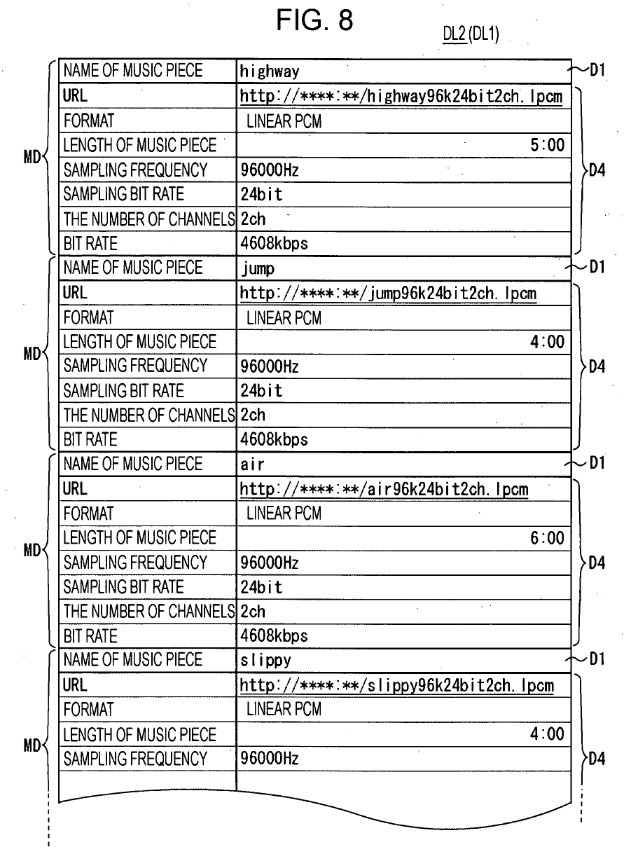

As a result, as in an example shown in FIG. 8, only the music name information D1 and the attribute information D4 concerning the audio data that can be subjected to the streaming playback in the configuration of the communication module 3 connected to the cradle 4 and that has the linear PCM format with the higher bit rate remain in each music piece information MD in the provision data list DL1. The communication module 3 sets the provision data list DL1 in this state as the playback data list DL2.

In contrast, if the communication module 3 is connected to the server 2 according to the wireless LAN standard having a maximum communication speed of 11 Mbps, the wireless communication speed is varied under various conditions. Accordingly, it is desirable for the audio data to have a lower bit rate in order to reliably transmit the audio data having the linear PCM format without any sound break.

Accordingly, the communication module 3 keeps the attribute information D3 concerning the audio data with the lower bit rate and deletes the attribute information D4 concerning the audio data having the data format with the higher bit rate from the provision data list DL1.

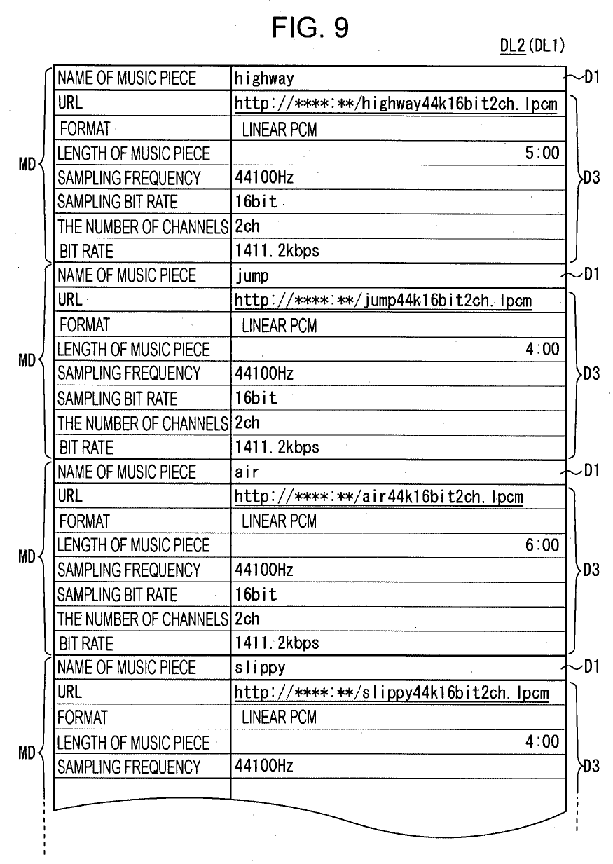

As a result, as in an example shown in FIG. 9, only the music name information D1 and the attribute information D3 concerning the audio data that can be subjected to the streaming playback in the configuration of the communication module 3 connected to the cradle 4 and that has the linear PCM format with the lower bit rate remain in each music piece information MD in the provision data list DL1. The communication module 3 sets the provision data list DL1 in this state as the playback data list DL2.

As described above, if the communication speed between the communication module 3 and the server 2 is sufficient to transmit the audio data which the server 2 can supply, the playback data list DL2 indicates the audio data that can be subjected to the streaming playback in the configuration of the communication module 3 connected to the cradle 4 and that has the data format with the higher bit rate, among the audio data having the multiple data formats which the server 2 can supply. In contrast, if the communication speed between the communication module 3 and the server 2 is not necessarily sufficient to transmit the audio data which the server 2 can supply, the playback data list DL2 indicates the audio data that can be subjected to the streaming playback in the configuration of the communication module 3 connected to the cradle 4 and that has the data format with the lower bit rate, among the audio data having the multiple data formats which the server 2 can supply. The communication module 3 acquires the audio data indicated in the playback data list DL2 in the above manner from the server 2 and performs the streaming playback to the acquired audio data.

### Process of Playing Back Audio Data

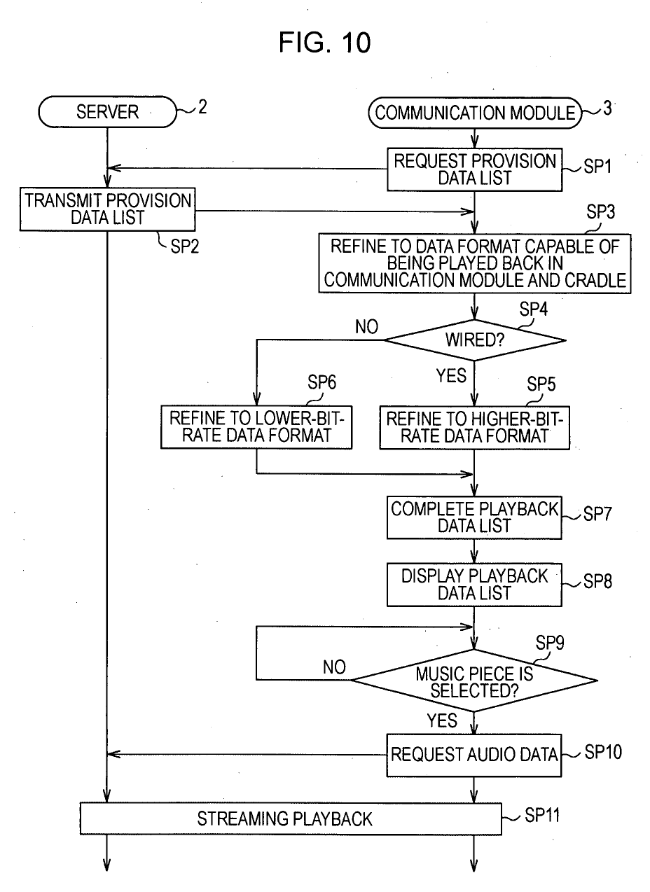

A process of acquiring the provision data list DL1 from the server 2 and playing back the audio data, performed in the communication module 3, will now be described with reference to a flowchart shown in FIG. 10. The process of playing back the audio data is performed by the MPU 10 in the communication module 3 in accordance with the programs read out from the memory (not shown) in the MPU 10 and by the CPU 30 in the server 2 in accordance with the programs read out from the hard disk drive 31 or the ROM 32. It is assumed here that the wireless or wired connection is established between the communication module 3 and the server 2.

Referring to FIG. 10, after recognizing the list acquisition operation to acquire the provision data list DL1, in Step SP1, the MPU 10 in the communication module 3 transmits the list request signal to the server 2. In Step SP2, the CPU 30 in the server 2 transmits the provision data list DL1 to the communication module 3 in response to the list request signal received from the communication module 3.

After receiving the provision data list DL1 from the server 2, in Step SP3, the MPU 10 in the communication module 3 deletes the attribute information D2 concerning the audio data having the mp3 format, which is not suitable for the streaming playback in the configuration of the communication module 3 connected to the cradle 4, from the provision data list DL1 to refine the audio data having the multiple data formats described in the provision data list DL1 to the audio data having the data format which can be subjected to the streaming playback in the configuration of the communication module 3 connected to the cradle 4 (that is, the audio data having the linear PCM format), as in the example shown in FIG. 7.

In Step SP4, the MPU 10 determines whether the wired connection is established with the server 2. If the determination is affirmative, the MPU 10 recognizes that the wired connection is established with the server 2 and goes to Step SP5. In Step SP5, the MPU 10 deletes the attribute information D3, other than the attribute information D4 concerning the audio data having the linear PCM format with the higher bit rate, from the provision data list DL1 from which the attribute information D2 concerning the audio data having the mp3 format is deleted in Step SP3 to refine the audio data having the multiple data formats described in the provision data list DL1 to the audio data that can be subjected to the streaming playback in the configuration of the communication module 3 connected to the cradle 4 and that has the data format with the highest bit rate (that is, the audio data having the linear PCM format with the bit rate “4608 kbps”) for every music piece information MD, as in the example shown in FIG. 8.

If the determination is negative in Step SP4, the MPU 10 recognizes that the wireless connection is established with the server 2 and goes to Step SP6. In Step SP6, the MPU 10 deletes the attribute information D4, other than the attribute information D3 concerning the audio data having the linear PCM format with the lower bit rate, from the provision data list DL1 from which the attribute information D2 concerning the audio data having the mp3 format is deleted in Step SP3 to refine the audio data having the multiple data formats described in the provision data list DL1 to the audio data that can be subjected to the streaming playback in the configuration of the communication module 3 connected to the cradle 4 and that has the data format with the lowest bit rate (that is, the audio data having the linear PCM format with the bit rate “1411.2 kbps”) for every music piece information MD, as in the example shown in FIG. 9.

In Step SP7, the MPU 10 sets the provision data list DL1 in which the data format of the audio data is refined for every music piece information MD in Step SP5 or Step SP6 as the playback data list DL2. In Step SP8, the MPU 10 displays the playback data list DL2 in the display 14.

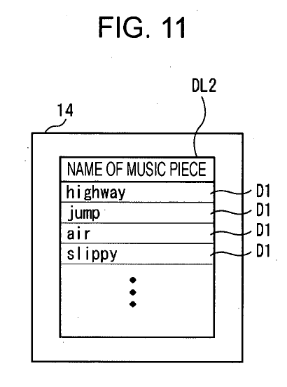

As in an example shown in FIG. 11, the MPU 10 displays only the music name information D1 in the playback data list DL2 in the display 14. In other words, the names of music pieces that are received from the server 2 and that can be subjected to the streaming playback in the communication module 3 and the cradle 4 are displayed in the display 14. After displaying the playback data list DL2, the MPU 10 goes to Step SP9.

In Step SP9, the MPU 10 waits for a playback operation of selecting any piece of the music name information D1 from the multiple pieces of the music name information D1 displayed in the display 14 and, after recognizing the playback operation, goes to Step SP10. In Step SP10, the MPU 10 acquires the URL of the audio data corresponding to the selected piece of music name information D1 from the playback data list DL2.

The URL includes the portion (for example, “http://***:**”; hereinafter referred to as a server identifier) indicating the address of the server 2 and the portion (for example, “highway44k16 bit2ch.lpcm”; hereinafter referred to as an audio data identifier) indicating the file name, music name, format, and bit rate of the audio data, as described above. The MPU 10 transmits the audio data request signal requesting the audio data identified with the audio data identifier (for example, “highway44k16 bit2ch.lpcm”) to the server 2 on the basis of this URL.

After receiving the audio data request signal from the communication module 3, in Step SP11, the CPU 30 in the server 2 reads out the audio data having the mp3 format, corresponding to the audio data identifier (for example, “highway44k16 bit2ch.lpcm”) indicated in the audio data request signal, from the hard disk drive 31. The CPU 30 in the server 2 yields the audio data having the data format requested from the communication module 3 by performing the digital processing based on the format and bit rate indicated in the audio data identifier (for example, “highway44k16 bit2ch.lpcm”) to the readout audio data in the sound processor 35 and transmits the yielded audio data to the communication module 3.

The MPU 10 in the communication module 3 performs the streaming playback to the audio data transmitted from the server 2 to yield a sound based on the audio data and outputs the sound using the speaker SP in the cradle 4. The streaming playback of the audio data is performed among the server 2, the communication module 3, and the cradle 4 in the manner described above.

The audio system 1 plays back the audio data in accordance with the above playback process.

### Operation and Advantages of First Embodiment

In the audio system 1 having the above configuration, the server 2 provides the audio data concerning each music piece in the multiple data formats (the mp3 format, the linear PCM format with the lower bit rate, and the linear PCM format with the higher bit rate) and transmits the provision data list DL1 in which the audio data having the multiple data formats for every music piece is described to the communication module 3.

The communication module 3 receives the provision data list DL1 and refines the data formats of the audio data described in the provision data list DL1 to the data formats (the linear PCM formats with the lower and higher bit rates) which can be subjected to the streaming playback in the configuration of the communication module 3 connected to the cradle 4 for every music piece.

If the communication module 3 is connected to the server 2 according to the wired LAN standard providing the communication speed sufficient to transmit the audio data having the data formats (the linear PCM formats with the lower and higher bit rates) which can be subjected to the streaming playback in the configuration of the communication module 3 connected to the cradle 4 from the server 2 to the communication-module 3, the communication module 3 refines the data formats (the linear PCM formats with the lower and higher bit rates) which can be subjected to the streaming playback in the configuration of the communication module 3 connected to the cradle 4 to the data format with the highest bit rate and acquires the audio data having the data format with the highest bit rate from the server 2 to perform the streaming playback to the acquired audio data.

In other words, if the communication module 3 is connected to the server 2 according to the wired LAN standard providing the communication speed sufficient to transmit the audio data, the communication module 3 can acquire the audio data having the data format that can be subjected to the streaming playback in the configuration of the communication module 3 connected to the cradle 4 and that provides the highest sound quality from the server 2 to reliably play back the audio data with higher sound quality.

In contrast, if the communication module 3 is connected to the server 2 according to the wireless LAN standard that does not necessarily provide the communication speed sufficient to transmit the audio data having the data formats (the linear PCM formats with the lower and higher bit rates) which can be subjected to the streaming playback in the configuration of the communication module 3 connected to the cradle 4 from the server 2 to the communication module 3, the communication module 3 refines the data formats (the linear PCM formats with the lower and higher bit rates) which can be subjected to the streaming playback in the configuration of the communication module 3 connected to the cradle 4 to the data format with the lowest bit rate and acquires the audio data having the data format with the lowest bit rate from the server 2 to perform the streaming playback to the acquired audio data.

In other words, if the communication module 3 is connected to the server 2 according to the wireless LAN standard that does not necessarily provide the communication speed sufficient to transmit the audio data, the communication module 3 can acquire the audio data having the data format with less data drop, which can be subjected to the streaming playback in the configuration of the communication module 3 connected to the cradle 4, from the server 2 to reliably play back the audio data without sound jumpiness although the sound quality is reduced.

As described above, in the audio system 1, the multiple data formats which the server 2 can supply are refined to the data format that can be subjected to the streaming playback in the configuration of the communication module 3 connected to the cradle 4 and that is suitable for the connection method between the server 2 and the communication module 3, so that it is possible to select the audio data having the data format suitable for the playback in the communication module 3 and the cradle 4 from the audio data having the multiple data formats which the server 2 can supply.

In the audio system 1 having the above configuration, the data formats of the audio data transmitted from the server 2, which is capable of transmitting the audio data in at least one data format, to the communication module 3 are refined on the basis of the playback conditions when the communication module 3 receives and plays back the audio data. The playback conditions include the determination of whether the data format can be played back in the configuration of the communication module 3 connected to the cradle 4 and the determination of whether the wired or wireless connection is established between the server 2 and the communication module 3. Consequently, it is possible to select the audio data having the data format suitable for the playback in the communication module 3 connected to the cradle 4.

### Second Embodiment

A second embodiment of the present invention will now be described. The second embodiment of the present invention is substantially similar to the first embodiment of the present invention described above except that the data formats of the audio data described in the provision data list DL1 are refined in the server 2, instead of the communication module 3. Description of the configurations of the communication module 3, the cradle 4, and the server 2 similar to those in the first embodiment is omitted herein. Only a process of playing back the audio data, which is different from that in the first embodiment, will now be described.

### Process of Playing Back Audio Data

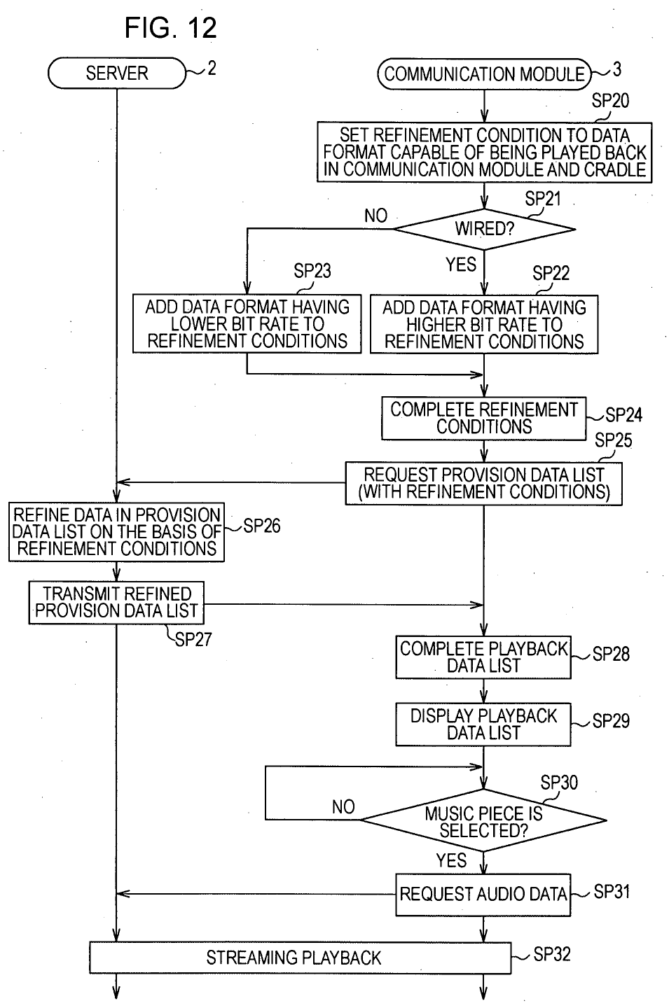

A process of playing back the audio data according to the second embodiment of the present invention will now be described with reference to a flowchart shown in FIG. 12. The process of playing back the audio data is performed by the MPU 10 in the communication module 3 in accordance with the programs read out from the memory (not shown) in the MPU 10 and by the CPU 30 in the server 2 in accordance with the programs read out from the hard disk drive 31 or the ROM 32, as in the first embodiment. It is assumed here that the wireless or wired connection is established between the communication module 3 and the server 2.

Referring to FIG. 12, in Step SP20, the MPU 10 in the communication module 3 sets the condition that the data format of the audio data, which can be subjected to the streaming playback in the configuration of the communication module 3 connected to the cradle 4, be the linear PCM format as a condition (hereinafter also referred to as a refinement condition) used for refining the data formats of the audio data in the server 2.

In Step SP21, the MPU 10 determines whether the wired connection is established with the server 2. If the determination is affirmative, the MPU 10 recognizes that the wired connection is established with the server 2 and goes to Step SP22. In Step SP22, the MPU 10 adds the condition that the audio data have the data format with the higher bit rate to the refinement condition set in Step SP20 to set the refinement condition to the linear PCM format with the higher bit rate.

If the determination is negative in Step SP22, the MPU 10 recognizes that the wireless connection is established with the server 2 and goes to Step SP23. In Step SP23, the MPU 10 adds the condition that the audio data have the data format with the lower bit rate to the refinement condition set in Step SP20 to set the refinement condition to the linear PCM format with the lower bit rate.

In Step SP24, the MPU 10 recognizes that the refinement condition has been set and goes to Step SP25. In Step SP25, the MPU 10 transmits the list request signal that includes the refinement condition and that requests the provision data list DL1 to the server 2.

After receiving the list request signal from the communication module 3, in Step SP26, the CPU 30 in the server 2 refines the data formats of the audio data described in the provision data list DL1 on the basis of the refinement condition included in the list request signal. As a result, as in the example shown in FIG. 8 or 9, the provision data list DL1 indicates only the audio data having the data format that can be played back in the configuration of the communication module 3 connected to the cradle 4 and that is suitable for the connection method between the server 2 and the communication module 3.

In Step SP27, the CPU 30 transmits the provision data list DL1, in which only the audio data having the data format that can be played back in the configuration of the communication module 3 connected to the cradle 4 and that is suitable for the connection method between the server 2 and the communication module 3 is described, to the communication module 3.

After receiving the provision data list DL1 from the server 2, in Step SP28, the MPU 10 in the communication module 3 sets the provision data list DL1 as the playback data list DL2. In Step SP29, the MPU 10 displays only the music name information D1 in the playback data list DL2 in the display 14, as in the first embodiment.

In Step SP30, the MPU 10 waits for a playback operation of selecting any piece of the music name information D1 from the multiple pieces of the music name information D1 displayed in the display 14 and, after recognizing the playback operation, goes to Step SP31. In Step SP31, the MPU 10 acquires the URL of the audio data corresponding to the selected piece of music name information D1 from the playback data list DL2. The MPU 10, then, transmits the audio data request signal requesting the audio data to the server 2 on the basis of the server identifier (for example, “http://***:**”) and the audio data identifier (for example, “highway44k16 bit2ch.lpcm”) included in the URL.

After receiving the audio data request signal from the communication module 3, in Step SP32, the CPU 30 in the server 2 reads out the audio data having the mp3 format, corresponding to the audio data identifier (for example, “highway44k16 bit2ch.lpcm”) indicated in the audio data request signal, from the hard disk drive 31. The CPU 30 in the server 2 yields the audio data having the data format requested from the communication module 3 by performing the digital processing based on the format and bit rate indicated in the audio data identifier (for example, “highway44k16 bit2ch.lpcm”) to the readout audio data in the sound processor 35 and transmits the yielded audio data to the communication module 3.

The MPU 10 in the communication module 3 performs the streaming playback to the audio data transmitted from the server 2 to yield a sound based on the audio data and outputs the sound using the speaker SP in the cradle 4. The streaming playback of the audio data is performed among the server 2, the communication module 3, and the cradle 4 in the manner described above.

### Operation and Advantages of Second Embodiment

In the audio system 1 having the above configuration described above, the communication module 3 sets the refinement condition used for refining the data formats of the audio data which the server 2 can supply to the data format that can be played back in the configurations of the communication module 3 and the cradle 4 and that is suitable for the connection method between the server 2 and the communication module 3 and transmits the set refinement condition to the server 2.

The server 2 refines the data formats of the audio data which the server 2 can supply to the data format that can be played back in the configurations of the communication module 3 and the cradle 4 and that is suitable for the connection method between the server 2 and the communication module 3, on the basis of the refinement condition. The server 2, then, transmits the provision data list DL1 in which the audio data having the data format refined in advance is described to the communication module 3.

As described above, in the audio system 1 according to the second embodiment of the present invention, the server 2, instead of the communication module 3, refines the data formats of the audio data which the server 2 can supply, so that it is possible to reduce the processing load on the communication module 3. Practically, since the performance of the communication module 3 is often lower than that of the server 2, the processing in the communication module 3 can be performed in the server 2 to reduce the processing time.

In addition, in the audio system 1 according to the second embodiment of the present invention, the server 2 transmits the provision data list DL1 in which the audio data having the data format refined in advance is described to the communication module 3, so that the amount of data of the provision data list DL1 transmitted from the server 2 to the communication module 3 can be reduced. As a result, it is possible to reduce the load of the network over which the server 2 communicates with the communication module 3.

### Other Embodiments

In the first and second embodiments of the present invention described above, the server 2 stores only the audio data having the mp3 format for every music piece and converts the mp3 format into the linear PCM format with the lower bit rate and the linear PCM format with the higher bit rate to provide the audio data having the three data formats including the mp3 format, the linear PCM format with the lower bit rate, and the linear PCM format with the higher bit rate for every music piece. However, the present invention is not limited to this case. The server 2 may store the audio data having at least one data format for every music piece and may transmit only the stored audio data to the communication module 3.

In this case, the server 2 can transmit the audio data having the three data formats to the communication module 3 in the case of the music pieces for which the audio data having the three data formats including the mp3 format, the linear PCM format with the lower bit rate, and the linear PCM format with the higher bit rate is stored while the server 2 can transmit only the audio data having the mp3 format in the case of the music pieces for which only the audio data having the mp3 format is stored.

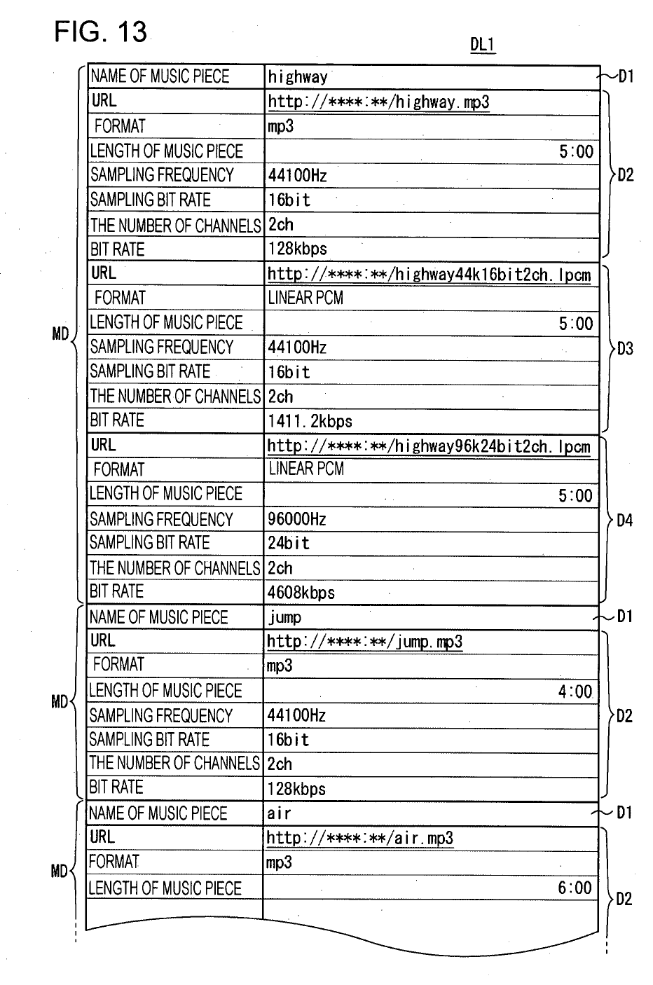

Accordingly, the provision data list DL1 includes, for example, the music piece information MD including the music name information D1, the attribute information D2 concerning the mp3 format, the attribute information D3 concerning the linear PCM format with the lower bit rate, and the attribute information D4 concerning the linear PCM format with the higher bit rate; the music piece information MD including the music name information D1, the attribute information D2, and the attribute information D3; and the music piece information MD including only the music name information D1 and the attribute information D2, as in an example shown in FIG. 13,

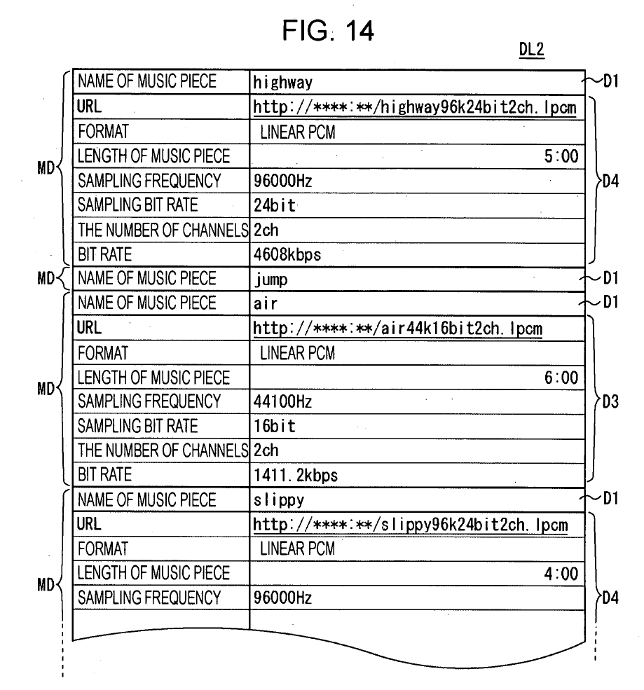

Since the data formats of the audio data can be refined by using the playback process described in the first and second embodiments even if different music pieces have different combinations of the data formats of the audio data, advantages similar to those in the first and second embodiment of the present invention can be achieved in this case. However, some pieces of the audio data can be provided only in the data format (for example, the mp3 format) which is not suitable for the playback in the communication module 3 and the cradle 4. As a result, the playback data list DL2 includes the music piece information MD including only the music name information D1, as in an example shown in FIG. 14.

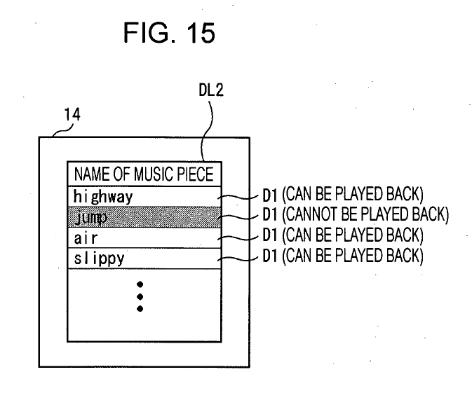

The music piece information MD including only the music name information D1 indicates a music piece which the server 2 can supply but which is not suitable for the playback in the communication module 3 and the cradle 4. When the communication module 3 displays such a playback data list DL2 in the display 14, the communication module 3 displays the music name information D1 concerning the music piece that is not suitable for the playback so as not to be selected in a manner different from that of the music name information D1 concerning the music pieces that can be played back, as in an example shown in FIG. 15. The communication module 3 can indicate to a user that the playback data list DL2 includes the music piece that is not suitable for the playback in the above manner.

In the above case, the playback data list DL2 can include both the music piece information MD including the music name information D1 and the attribute information D3 concerning the audio data having the linear PCM format with the lower bit rate and the music piece information MD including the music name information D1 and the attribute information D4 concerning the audio data having the linear PCM format with the higher bit rate, as in the example shown in FIG. 14. In other words, the bit rate of the audio data can vary depending on the music pieces.

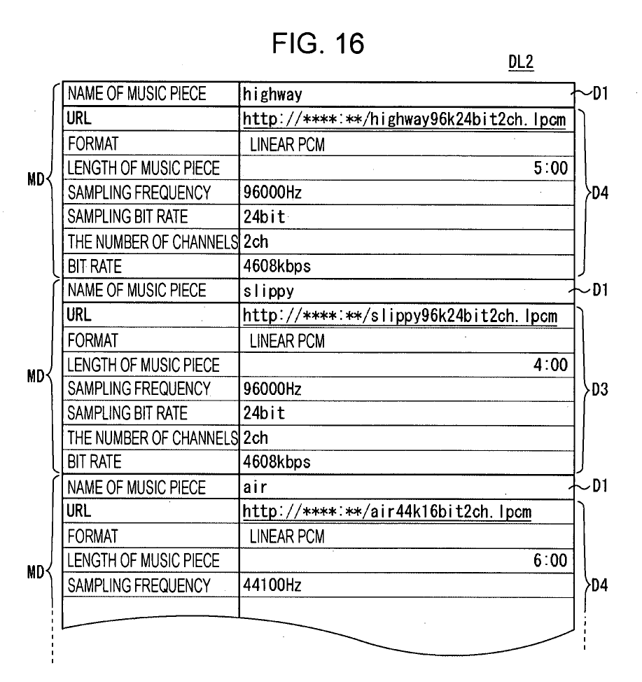

Accordingly, as in an example shown in FIG. 16, the communication module 3 may sort the pieces of the music piece information MD in the playback data list DL2 in descending or ascending order of the bit rate to display the sorted playback data list DL2 in the display 14. In this manner, the communication module 3 can indicate to the user the music pieces that are arranged in descending order of the sound quality or in ascending order of the probability of the sound break. Whether the pieces of the music piece information MD are arranged in descending or ascending order of the bit rate is determined by, for example, the user.

The present invention is also applicable to the server 2 that does not include the sound processor 35 converting the data format of the audio data if only the audio data stored in the server 2 is transmitted to the communication module 3, as described above.

Although the audio data having the multiple data formats which the server 2 can supply is refined to the audio data having the data format that can be played back in the configuration of the communication module 3 connected to the cradle 4 and that is suitable for the connection method between the server 2 and the communication module 3 in the first and second embodiments of the present invention, the present invention is not limited to this. For example, after the audio data having the multiple data formats which the server 2 can supply are refined to the audio data having the data format that can be played back in the configuration of the communication module 3 connected to the cradle 4, the user may select a piece of the audio data having an arbitrary data format from the pieces of the audio data having the data format that can be played back in the configuration of the communication module 3 connected to the cradle 4.

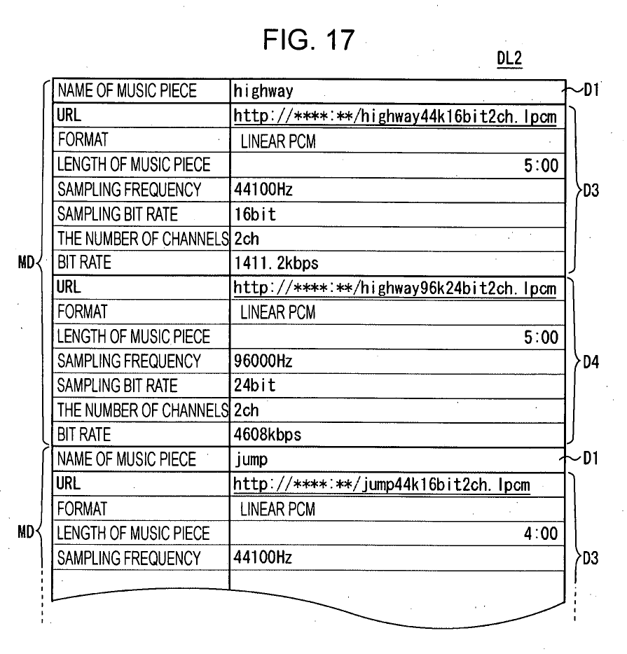

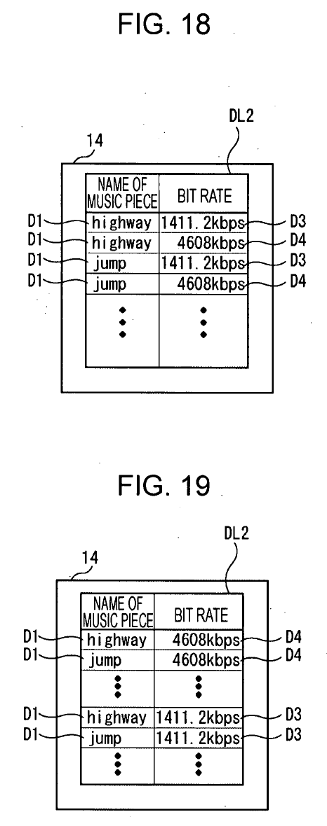

In this case, each music piece information MD in the attribute information D2 includes the music name information D1, the attribute information D3 concerning the audio data having the linear PCM format with the lower bit rate, which can be played back in the configuration of the communication module 3 connected to the cradle 4, and the attribute information D4 concerning the audio data having the linear PCM format with the higher bit rate, which can be played back in the configuration of the communication module 3 connected to the cradle 4, as in an example shown in FIG. 17. In other words, the playback data list DL2 includes all the pieces of the audio data having the data formats that can by played back in the configuration of the communication module 3 connected to the cradle 4. When the communication module 3 displays such a playback data list DL2 in the display 14, the communication module 3 displays the attribute information D3 (for example, having the bit rate “1411.2 kbps”) and the attribute information D4 (for example, having the bit rate “4606 kbps”) associated with the music name information D1, as in an example shown in FIG. 18, to allow the user to select either the attribute information D3 or the attribute information D4 for every music piece.

In the above manner, the communication module 3 allows the user to select the audio data having the linear PCM format with the lower bit rate or having the linear PCM format with the higher bit rate from the pieces of the audio data having the linear PCM format that can be played back in the configuration of the communication module 3 connected to the cradle 4.

The communication module 3 may sort the pieces of the music piece information MD in the playback data list DL2, in which all the pieces of the audio data having the data formats that can be played back in the configuration of the communication module 3 connected to the cradle 4 are described, in descending or ascending order of the bit rate to display the sorted playback data list DL2 in the display 14, as in an example shown in FIG. 19. In this manner, the communication module 3 can indicate to the user the music pieces that are arranged in descending order of the sound quality or in ascending order of the probability of the sound break to allow the user to select the music piece.

Although the server 2 converts the audio data having the mp3 format, stored in the server 2, into the audio data having the linear PCM format and transmits the audio data having the linear PCM format to the communication module 3 in the first and second embodiments of the present invention, the present invention is not limited to this. The audio data having the mp3 format may be stored in another server connected to the server 2 over a network, and the other server may convert the audio data having the mp3 format into the audio data having the linear PCM format in response to an instruction from the server 2 to transmit the audio data having the linear PCM format to the server 2. The audio data having the linear PCM format, transmitted from the other server, may be relayed via the server 2 to the communication module 3.

Specifically, after the server 2 receives the audio data request signal requesting the audio data having, for example, the linear PCM format with the lower bit rate from the communication module 3, the server 2 transmits the audio data identifier (for example, “highway44k16 bit2ch.lpcm”) indicated in the audio data request signal to the other server. The other server converts the audio data having the corresponding mp3 format into the audio data having the linear PCM format with the lower bit rate (the linear PCM format with the sampling frequency “44100 kHz”, the sampling bit rate “16 bits”, and the number of channels “2ch”) on the basis of the audio data identifier and transmits the audio data having the converted data format to the server 2. The audio data having the linear PCM format with the lower bit rate, transmitted from the other server, is relayed via the server 2 to the communication module 3.

With this method, in the audio system 1, the load on the server 2 can be distributed even if multiple communication modules 3 access the server 2. As a result, it is possible to prevent any sound break to reliably play back the audio data.

If the other server does not have the function of converting the audio data having the mp3 format into the audio data having the linear PCM format, the server 2 may receive the audio data having the mp3 format from the other server, may convert the audio data having the mp3 format into the audio data having the linear PCM format, and may transmit the audio data having the linear PCM format to the communication module 3. In this case, the other server may be a general-purpose server.

In addition, the server 2 may receive audio data (hereinafter referred to as radio program data) concerning a radio program (so-called network radio program) delivered from the other server and may transmit the radio program data to the communication module 3. In this case, the server 2 transmits the provision data list in which the radio program data having multiple data formats which the server 2 can supply is described to the communication module 3. The communication module 3 refines the radio program data having the multiple data formats described in the provision data list in the manner as in the first and second embodiments and requests the radio program data having the refined data format from the server 2. The server 2 receives the radio program data delivered from the other server in response to the request, converts the data format of the received radio program data into a data format specified by the communication module 3, and transmits the radio program data having the converted data format to the communication module 3. In the audio system 1, it is possible to play back the radio program data delivered from a server other than the server 2 in the above manner.

Although the data format of the audio data which can be played back in the communication module 3 and the cradle 4 is the linear PCM format in the first and second embodiments of the present invention, the present invention is not limited to this. For example, a sound processor for processing the audio data having the mp3 format may be provided in the communication module 3 to play back the audio data having the mp3 format. Or, a D/A converter for processing the audio data having a direct stream digital (DSD) format may be provided in the communication module 3 to play back the audio data having the DSD format. Alternatively, the communication module 3 may accommodate the audio data having other various formats, such as Adaptive TRansform Acoustic Coding 3 (ATRAC3 (Registered Trademark of Sony Corporation)) and Windows Media Audio (WMA®). Alternatively, interpolation data used for returning the compressed and encoded audio data to the original audio data may be stored apart from the audio data, and the interpolation data may be used to accommodate the audio data having the data format, which can be returned to the original audio data.

Although the bit rate is used as the refinement condition when the data format that can be played back in the configuration of the communication module 3 connected to the cradle 4 is refined to the data format suitable for the connection method between the server 2 and the communication module 3 in the first and second embodiments of the present invention, the present invention is not limited to this. For example, the format, the sampling frequency, or the sampling bit rate may be used as the refinement condition in the above case.

For example, when both the data format of the audio data which the server 2 can supply and the data format of the audio data which can be played back in the communication module 3 and the cradle 4 are the mp3 format, the linear PCM format having a sound quality higher than that of the mp3 format, or the DSD format having a sound quality higher than that of the linear PCM format, if the wired connection is established between the server 2 and the communication module 3, the refinement condition in the refinement to the data format suitable for the connection method between the server 2 and the communication module 3 is the data format with the highest sound quality. Accordingly, for every music piece, the data formats are first refined to the data format with the highest sound quality, are then refined to the data format with the highest sampling frequency if there are pieces of the audio data having the same data format but having different sampling frequencies, and are finally refined to the data format with the highest sampling bit rate if there are pieces of the audio data having the same format and sampling frequency but having different sampling bit rates.

In contrast, if the wireless connection is established between the server 2 and the communication module 3, the refinement condition in the refinement to the data format suitable for the connection method between the server 2 and the communication module 3 is the data format that is least subjected to the sound break. Accordingly, the data formats are refined in the reverse order of the one when the data format with the highest sound quality is refined.

Although the refinement condition is switched in accordance with the determination of whether the wired or wireless connection is established between the server 2 and the communication module 3 in the refinement to the data format suitable for the connection method between the server 2 and the communication module 3 in the first and second embodiments of the present invention, the present invention is not limited to this. The refinement condition may be switched in accordance with the wired or wireless LAN standard.

Specifically, when the wireless LAN standard providing the communication speed sufficient to transmit the audio data which the server 2 can supply is used if the wireless connection is established between the server 2 and the communication module 3, the data formats may be refined to the data format with the highest sound quality. When the wired LAN standard that does not necessarily provide the communication speed sufficient to transmit the audio data which the server 2 can supply is used if the wired connection is established between the server 2 and the communication module 3, the data formats may be refined to the data format with a bit rate lower than the communication speed between the server 2 and the communication module 3. In sum, the data formats are refined to the data format that can be played back with a good sound quality without any sound break at the communication speed between the server 2 and the communication module 3.

If the wireless connection is established between the server 2 and the communication module 3, the communication module 3 may communicate with the server 2 at predetermined intervals to measure the communication speed between the server 2 and the communication module 3 and may switch the refinement condition in accordance with the measured communication speed. In this case, for example, if the communication speed between the server 2 and the communication module 3 is greatly reduced during the streaming playback of the audio data, the communication module 3 may pause the streaming playback of the audio data, may switch the refinement condition to refine the data format of the audio data to the data format with a lower bit rate, and may generate the playback data list DL2 again to perform the streaming playback of the audio data having the data format with the lower bit rate. The streaming playback may be restarted at the beginning of the music piece that is paused. Alternatively, the time when the streaming playback is paused may be stored and the streaming playback may be restarted at the stored time.

Although the data format that can be played back in the communication module 3 and the cradle 4 is the linear PCM format in the first and second embodiments of the present invention, the linear PCM format having the sampling frequency and the sampling bit rate that are not supported by the D/A converter 16 in the communication module 3 is determined to the data format that is not suitable for the playback.

Although the wired or wireless connection is established between the server 2 and the communication module 3 in the first and second embodiments of the present invention, the present invention is not limited to this connection. The wired and wireless connection may be established between the server 2 and the communication module 3. In this case, the wired communication is actually achieved. If the wired connection is broken, for example, because of the disconnection of the cable when the wired and wireless connection is established between the server 2 and the communication module 3, the wired communication may be switched to the wireless communication.

Although both the refinement to the data format that can be played back in the configuration of the communication module 3 connected to the cradle 4 and the subsequent refinement to the data format suitable for the connection method between the server 2 and the communication module 3 are performed in either the server 2 or the communication module 3 in the first and second embodiments of the present invention, the present invention is not limited to this. One of the two refinements may be performed in the server 2 and the other may be performed in the communication module 3.

Although the present invention is applied to the audio system 1 processing the audio data in the first and second embodiments of the present invention, the present invention is not limited to this. The present invention may be applied to a system processing a variety of data continuously played back, such as a video system processing video data.

Although not only the name of the music piece but also the sampling frequency, the sampling bit rate, and the number of channels, used for calculating the bit rate, are included in the file name of the audio data, included in each URL in the attribute information D3 and the attribute information D4, in the first and second embodiments of the present invention, the present invention is not limited to this. The bit rate itself, in addition to the name of the music piece, may be included in the file name of the audio data.

Although any audio data, for example, corresponding to few seconds, accumulated in the buffer 15 during the streaming playback in the communication module 3 is supplied to the D/A converter 16 and is deleted from the buffer 15 in the first and second embodiments of the present invention, the present invention is not limited to this. Part of the accumulated audio data may be supplied to the D/A converter 16 and deleted from the buffer 15 so that the audio data corresponding to few seconds constantly remains in the buffer 15. Also in this case, the audio data remaining in the buffer 15 is only temporarily accumulated and is not kept after the streaming playback.

Although the communication module 3 performs the digital-to-analog conversion to the audio data to convert the audio data into the audio signal and transmits the audio signal to the cradle 4 in the first and second embodiments of the present invention, the present invention is not limited to this. The communication module 3 may transmit the audio data to the cradle 4 without conversion. In this case, the cradle 4 directly supplies the audio data to the sound processor 23.

Although the playback data list including the music piece information MD composed of the music name information D1 and the attribute information in the refined data format is used as management information in the first and second embodiments of the present invention, the present invention is not limited to this. Other kinds of management information may be used in the playback data list. For example, information concerning the name of an album in which the music piece is recorded, the name of an artist of the music piece, and the genre of the music piece may be included in the management information.

Although the direct wired or wireless connection is established between the server 2 and the communication module 3 in the first and second embodiments of the present invention, the present invention is not limited to this. For example, the wired connection may be established between the server 2 and the communication module 3 via a switching hub or the wireless connection may be established between the server 2 and the communication module 3 via a wireless access point connected to the server 2 by cable.

Although the URL including the server identifier and the audio data identifier is used as the information used for requesting the audio data having an arbitrary data format from the server 2 in the first and second embodiments of the present invention, the present invention is not limited to this. Other kinds of information may be used as long as the information can be used to request the audio data having an arbitrary data format from the server 2.

Although the MPU 10 in the communication module 3 performs the playback process described above in accordance with the programs installed in the memory in the MPU 10 in the first and second embodiments of the present invention, the present invention is not limited to this. The programs used in the playback process may be installed in a separate memory or may be recorded in a recording medium, such as a compact disc (CD).

Although the CPU 30 in the server 2 performs the playback process described above in accordance with the programs installed in the hard disk drive 31 or the ROM 32 in the first and second embodiments of the present invention, the present invention is not limited to this. The programs used in the playback process may be recorded in a recording medium, such as a CD.

Although the communication module 3, which serves as a data playback apparatus and a data selection apparatus, includes the MPU 10 serving as refining means, the operation keys 11, the wired LAN adopter 12, the display controller 13, the display 14, the buffer 15, the D/A converter 16, the module-side terminal 17, the wireless LAN adapter 18, and the infrared light receiver 19 in the first and second embodiments of the present invention, the present invention is not limited to this. The communication module 3 may have another configuration as long as the same function is provided.

Although the cradle 4 includes the cradle-side terminal 4B, the MPU 20, the operation keys 21, the A/D converter 22, the sound processor 23, the D/A converter 24, the amplifier 25, the display controller 26, the display 27, the infrared light receiver 28, and the speaker SP in the first and second embodiments of the present invention, the present invention is not limited to this. The cradle 4 may have another configuration as long as the same function is provided.

Although the server 2, which serves as a data transmission apparatus and a data selection apparatus, includes the CPU 30 serving as refining means, the hard disk drive 31, the ROM 32, the RAM 33, the wired LAN adopter 34, the sound processor 35, and the wireless LAN adopter 36 in the first and second embodiments of the present invention, the present invention is not limited to this. The server 2 may have another configuration as long as the same function is provided.

It should be understood by those skilled in the art that various modifications, combinations, sub-combinations and alterations may occur depending on design requirements and other factors insofar as they are within the scope of the appended claims or the equivalents thereof.

What is claimed is:

1. A data selection system comprising:
a data transmission apparatus; and
a data playback apparatus,
wherein the data transmission apparatus transmits pieces of data to be continuously played back in at least one data format, and
wherein the data playback apparatus refines the data format of the data transmitted from the data transmission apparatus on the basis of at least one playback condition for refining the data format of the data transmitted from the data transmission apparatus.

2. The data selection system according to claim 1,
wherein the data transmission apparatus receives at least one playback condition which the data playback apparatus uses in reception and playback of the data from the data playback apparatus and refines the data format of the data to be transmitted to the data playback apparatus on the basis of the playback condition.

3. The data selection system according to claim 1,
wherein the data playback apparatus refines the data format of the data received from the data transmission apparatus on the basis of at least one playback condition for receiving and playing back the data.

4. The data selection system according to claim 1,
wherein the data selection system generates management information concerning the data on the basis of how the data format is refined.

5. The data selection system according to claim 1,
wherein the playback condition is a data format that can be played back in the data playback apparatus.

6. The data selection system according to claim 1,
wherein the playback condition is a connection method between the data transmission apparatus and the data playback apparatus.

7. The data selection system according to claim 1,
wherein the playback conditions include a data format that can be played back in the data playback apparatus and a connection method between the data transmission apparatus and the data playback apparatus.

8. The data selection system according to claim 6,
wherein, if wired connection is established between the data transmission apparatus and the data playback apparatus, a higher priority is given to a data format with a higher quality in the refinement.

9. The data selection system according to claim 8,
wherein the data format with the higher quality has a higher data transfer rate.

10. The data selection system according to claim 6,
wherein, if wireless connection is established between the data transmission apparatus and the data playback apparatus, a hither priority is given to a data format with less data drop in the refinement.

11. The data selection system according to claim 10,
wherein the data format with less data drop has a lower data transfer rate.

12. The data selection system according to claim 4,
wherein the management information includes the pieces of the data which are arranged in descending order of quality.

13. The data selection system according to claim 4,
wherein the management information includes the pieces of the data which are arranged in ascending order of the probability of data drop.

14. A data selection apparatus comprising:
refining means for refining at least one data format of data to be continuously played back and to be transmitted from a data transmission apparatus to a data playback apparatus on the basis of a playback condition which the data playback apparatus uses in reception and playback of the data.

15. A data selection method comprising the step of:
refining at least one data format of data to be continuously played back and to be transmitted from a data transmission apparatus to a data playback apparatus on the basis of a playback condition which the data playback apparatus uses in reception and playback of the data.

16. A data selection program causing an information processing apparatus to execute the step of:
refining at least one data format of data to be continuously played back and to be transmitted from a data transmission apparatus to a data playback apparatus on the basis of a playback condition which the data playback apparatus uses in reception and playback of the data.

17. A data selection apparatus comprising:
a refining unit that refines at least one data format of data to be continuously played back and to be transmitted from a data transmission apparatus to a data playback apparatus on the basis of a playback condition which the data playback apparatus uses in reception and playback of the data.
